(19) United States
(12) Patent Application Publication
(10) Pub. No.: US 2023/0401075 A1
(43) Pub. Date: Dec. 14, 2023

(54) GRAPHICAL USER INTERFACE WITH PERFORMANCE INDICATORS FOR COMPUTING DEVICES OF A COMPUTER NETWORK

(71) Applicant: Truist Bank, Charlotte, NC (US)

(72) Inventors: Kenneth Hall, Roswell, GA (US); Bobby Len Robins, Raleigh, NC (US)

(73) Assignee: Truist Bank, Charlotte, NC (US)

(21) Appl. No.: 17/838,511

(22) Filed: Jun. 13, 2022

(51) Int. Cl. G06F 9/451; G06T 11/20; G06T 11/00; H04L 43/08

(52) U.S. Cl. CPC G06F 9/451; H04L 43/08; G06T 11/001; G06T 11/206

(57) ABSTRACT

A system can generate a graphical user interface that includes performance indicators associated with computing devices of a computer network. For example, the system can receive performance data relating to computing devices of a computer network. The performance data can include usage and capacity data for the computing devices. The system can determine scores by applying thresholds to the performance data. The scores can indicate a health of the computing devices. The system can generate a heat map based on the performance data. The heat map can visually indicate whether a computing device is overutilized or underutilized. The system can generate a user interface including the heat map, graphical objects representing the computing devices, and visual indicators associated with the graphical objects. The visual indicators can each depict a respective score indicating the health of a corresponding computing device.

### TECHNICAL FIELD

The present disclosure relates generally to graphical user interfaces. More particularly (although not necessarily exclusively), this disclosure relates to generating a graphical user interface that includes performance indicators, such as health scores and a heat map, for computing devices of a computer network.

### BACKGROUND

A computer network can experience varying demand for computing resources such as memory, processing power, and the like. For example, over a period of time, the computer network can experience an increase in demand for memory and processing power. Accordingly, computing devices, and any component thereof, of the computer network can experience an increase in usage, a decrease in usage, or some combination thereof over the period of time. Beyond varying demand, computing devices may also experience errors, faults, and other problems. These and other factors can impact the health of the computing devices.

### SUMMARY

In one example, a system can receive performance data relating to computing devices of a computer network. The performance data can include usage and capacity data for the computing devices. The system can determine scores by applying thresholds to the performance data. The scores can indicate a health of the computing devices. The system can also generate a heat map based on the performance data. The heat map can visually indicate whether a computing device is overutilized or underutilized. The system can generate a user interface including the heat map, graphical objects representing the computing devices, and visual indicators associated with the graphical objects. The visual indicators can each depict a respective score indicating the health of a corresponding computing device.

In another example, a method can involve receiving performance data relating to a plurality of computing devices in a computer network. The performance data can include usage data and capacity data relating to each computing device of the plurality of computing devices. The method can involve determining a set of scores by applying a set of thresholds to the performance data, and each score can indicate a health of a corresponding computing device. The method can also involve generating a heat map based on the performance data. The heat map can visually indicate whether each computing device is experiencing overutilization or underutilization. The method can involve generating a graphical user interface that includes the heat map, a set of graphical objects representing the computing devices, and visual indicators and associated with the graphical objects. Each visual indicator of the plurality of visual indicators can correspond to a respective graphical object and can depict a respective score. The respective score can indicate the health of the corresponding computing device represented by the respective graphical object. Some or all of the method can be implemented by a processor.

In a further example, a non-transitory computer-readable medium can include instructions that are executable by a processor for causing the processor to perform various operations. For example, performance data relating to a plurality of computing devices in a computer network can be received. The performance data can include usage data and capacity data relating to each computing device of the plurality of computing devices. A set of scores can be determined by applying a set of thresholds to the performance data, and each score can indicate a health of a corresponding computing device. A heat map can also be generated based on the performance data, and the heat map can visually indicate whether each computing device is experiencing overutilization or underutilization. A graphical user interface can be generated that includes the heat map, a set of graphical objects representing the computing devices, and visual indicators and associated with the graphical objects. Each visual indicator of the plurality of visual indicators can correspond to a respective graphical object and can depict a respective score. The respective score can indicate the health of the corresponding computing device represented by the respective graphical object.

### BRIEF DESCRIPTION OF THE DRAWINGS

FIG. 1 is a block diagram of an example of a network environment in which a performance indicator can be generated for a computer network according to one aspect of the present disclosure.

FIG. 2 is a block diagram of an example of a computing device configured to generate a graphical user interface that includes performance indicators, such as health scores and a heat map, for a computer network according to one example of the present disclosure.

FIG. 3 is a flowchart of an example of a process for generating a graphical user interface that includes performance indicators according to one example of the present disclosure.

FIG. 4 is an example of a graphical user interface that includes performance indicators corresponding to computing devices in a computer network according to one example of the present disclosure.

### DETAILED DESCRIPTION

Certain aspects and features relate to generating a graphical user interface that includes one or more performance indicators for monitoring the health of computing devices in a computer network. The computer network can include one or more computing devices. The one or more performance indicators can include a health score, a heat map, other suitable performance indicators, or any suitable combination thereof. The performance indicators can be generated for each computing device included in the computer network. For example, each computing device of the computer network can include a different health score and different values associated with the heat map. The health score for a given computing device can indicate a hardware health, a software health, or an overall health of the computing device. The heat map value for a given computing device can indicate utilization of the computing device. The health scores, the heat map, and any other suitable performance indicators can be provided via a graphical user interface generated for visualizing the performance indicators. The graphical user interface can include graphical objects that can represent each computing device, and the graphical user interface can include the heat map applied to the graphical objects. Additionally, each graphical object can have a corresponding health score, which indicates a health of a computing device represented by the graphical object.

A computer network can include a set of computing devices. Over a period of time, usage, health, and capacity of the computing devices of the computer network can change. For example, usage of a first computing device of the computer network can increase over time while usage of a second computing device of the computer network can decrease over time. Hardware and software components of the computing devices can also degrade over time. For example, a quality of computer memory of the particular computing device can decrease, one or more software modules executing on the particular computing device can become outdated, etc. Because multiple factors can impact the performance of a computing device at any given point in time, it can be challenging for network administrators to understand the performance (e.g., overall health) of each computing device in the network. And since the performance of the computing devices in the network can impact the overall operation of the network, it can be important for network administrators to understand how each computing device is performing, so that they can prevent or mitigate network problems.

Some examples of the present disclosure can generate overcome one or more of the abovementioned problems by generating performance indicators for computing devices included in a computer network. The performance indicators can be output in a graphical user interface and dynamically change over time. The performance indicators can indicate the health of the computing devices, usage of the computing devices, and other suitable performance information relating to the computing devices. For example, the performance indicators can include a health performance indicator. The health performance indicator can include a numerical score computed based on a variety of factors to indicate an overall health of the computing device. For example, a larger score may indicate a computing device that is healthier overall, which may involve a computing device with higher quality or newer computer memory, up-to-date or otherwise secure software modules, and the like. Additionally, the performance indicators can include a usage performance indicator. The usage performance indicator can include a visual indicator, such as heat map that has a color distribution, an amount of shading, and other suitable visual features, configured to indicate an amount of memory and processing power used by each computing device in the computer network. In some examples, the heat map may indicate whether a computing device is overutilized, underutilized, or within an allowable use range. The performance indicators can be used to help avoid or mitigate problems in the computer network. For example, a user or computer software (e.g., a security engine that includes a machine-learning model) may execute operations for preventing predicted problems or resolving identified problems based on the performance indicators.

A network performance engine can determine the performance indicators and can generate the corresponding graphical user interface that includes graphical representations depicting the performance indicators of the computing devices. For example, for each computing device included in a computer network, the network performance engine can calculate or otherwise determine a health score, a heat map, and other suitable performance indicators. In some examples, the network performance engine can generate the heat map for all of the computing devices included in the computer network. The health score can be determined using performance data. For example, performance data about computing devices of a computer network can be received, and one or more thresholds can be applied to the performance data to generate or otherwise determine the health scores. Additionally, the heat map can be determined. In some examples, the heat map can be applied to the computer network as-a-whole. For example, a usage of each computing device of the computer network may be determined, and a threshold, which may be different than the threshold used for the health score, may be applied to the usage of the computing devices. Based on the applied threshold, a usage determination can be made for each of the computing devices. For example, for each of the computing devices, a determination can be made of whether each of the computing devices is overutilized, underutilized, or neither (e.g., within an allowable usage range). The heat map may involve applying a different color, shading pattern, or other visual indicator to a representation of each of the computing devices indicating whether the respective computing device is overutilized, underutilized, or neither.

These illustrative examples are given to introduce the reader to the general subject matter discussed here and are not intended to limit the scope of the disclosed concepts. In the following description, for the purposes of explanation, specific details are set forth in order to provide a thorough understanding of various implementations and examples. Various implementations may be practiced without these specific details. The figures and description are not intended to be restrictive.

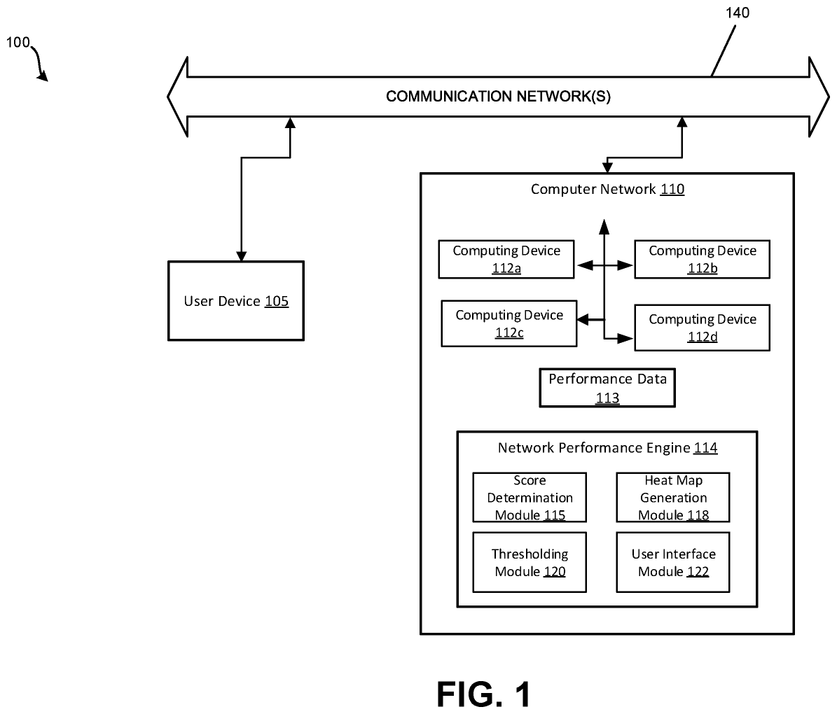

FIG. 1 is a block diagram of an example of a network environment 100 in which a performance indicator can be generated for a computer network according to one aspect of the present disclosure. Included in the network environment 100 are a user device 105, a computer network 110, and a communication network 140. The network environment 100 may correspond to a Wide Area Network (“WAN”) environment, such as the Internet, through which the user device 105 may communicate with the computer network 110 via web browsers or client-side applications, to establish communication sessions, request and receive web-based resources, and access other features of applications or services.

The computer network 110 may include one or more computing devices 112a-d and a network performance engine 114. The computing devices 112a-d can include any type of server including, for example, a rack server, a tower server, a miniature server, a blade server, a mini rack server, a mobile server, an ultra-dense server, a super server, or the like. The computing devices 112a-d may additionally or alternatively include other types of computing devices, such as desktop computers. The computing devices 112a-d may each include various hardware components such as, for example, a motherboard, processing units, memory systems, hard drives, network interfaces, power supplies, etc. The computing devices 112a-d may form one or more clusters or other networked arrangements. Additionally, the computing devices 112a-d of the computer network 110 may act according to stored instructions located thereon and may execute an operating system or other applications. In some examples, the computer network 110 may be a cloud-hosted system that exists on a server-less, cloud-based environment.

The computing devices 112a-d of the computer network 110 may implement several different applications and services, and perform additional server-side functionality. For example, in implementations of banking or financial services systems, electronic commerce systems, and the like, the computing devices 112a-d of the computer network 110 may be used to access, store, and maintain account information and perform various functions related to user accounts. In some examples, each computing device 112 can perform different functions.

The network performance engine 114 can include a score determination module 115, a heat map generation module 118, a thresholding module 120, a user interface module 122, and any other suitable module. The network performance engine 114 can receive performance data 113 from one or more of the computing devices 112a-d. The performance data 113 can include usage data, capacity data, and the like for corresponding computing devices 112. The score determination module 115 can be used to determine one or more health scores for one or more of the computing devices 112a-d of the computer network 110. The heat map generation module 118 can be used to generate a heat map corresponding to usage of the computer network 110. The thresholding module 120 can be used to determine thresholds or otherwise apply thresholds to performance data for generating the scores and the heat map for the computer network 110. The user interface module 122 can be used to generate a user interface that includes graphical representations of the computer network 110 for visualizing the scores and the heat map of the computer network 110.

In some examples, the user devices 105 can be used to access the computer network 110, or any component thereof such as the network performance engine 114, for viewing performance indicators relating to the computing devices 112a-d or to the computer network 110 as-a-whole. The user device 105, which can include any suitable user device for accessing web-based resources, application-based resources, or any suitable service of the computer network 110 can be capable of accessing and establishing communication sessions with the computer network 110 through the communication network 140. The user device 105 can include mobile devices, such as laptop computers, tablet computers, smartphones, and smart watches, which may access the computer network 110 via a Local Area Network (“LAN”) or Wide Area Network (WAN), as well as mobile telecommunication networks, short-range wireless networks, or various other communication network types (e.g., cable or satellite networks). Although certain examples herein are described in terms of mobile devices, in other examples, the user device 105 may additionally or alternatively include other mobile or non-mobile computing devices (e.g., desktop computers and servers) capable of accessing the computer network 110 via the communications network 140.

Although certain components are shown in FIG. 1, other suitable, compatible, network hardware components and network architecture designs may be implemented in various embodiments to support communication between the computer network 110, and the user device 105. Such communication network(s) may be any type of network that can support data communications using any of a variety of commercially-available protocols, including, without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, the network(s) connecting the user device 105 and the computer network 110 in FIG. 1 may be local area networks (LANs), such as one based on Ethernet, Token-Ring or the like. Such network(s) also may be wide-area networks, such as the Internet, or may include financial/banking networks, telecommunication networks such as a public switched telephone networks (PSTNs), cellular or other wireless networks, satellite networks, television/cable networks, or virtual networks such as an intranet or an extranet. Infrared and wireless networks (e.g., using the Institute of Electrical and Electronics (IEEE) 802.11 protocol suite or other wireless protocols) also may be included in these communication networks.

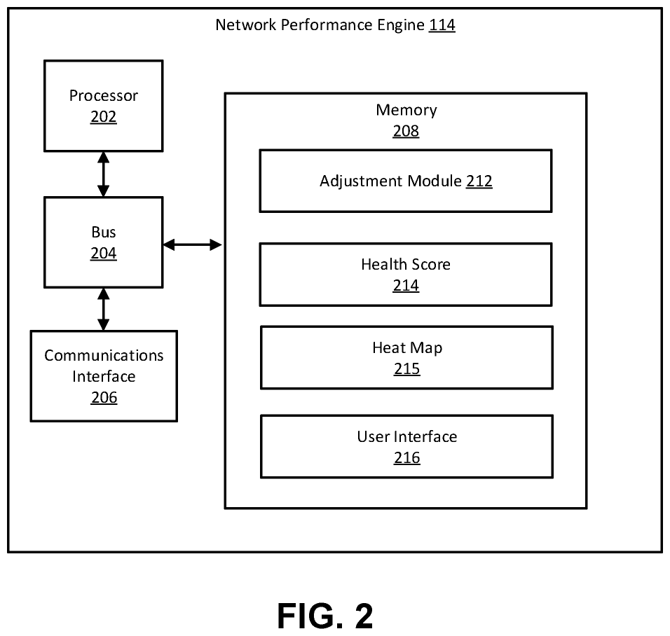

FIG. 2 is a block diagram of an example of a computing device configured to generate a graphical user interface that includes performance indicators, such as health scores and a heat map, for a computer network according to one example of the present disclosure. In some examples, the computing device is a network performance engine 114. The network performance engine 114 may include a processor 202, a bus 204, a communications interface 206, a memory 208, and any other suitable computing device components. In some examples, the components illustrated in FIG. 2 may be integrated into a single structure. For example, the components can be within a single housing. In other examples, the components illustrated in FIG. 2 can be distributed, such as in separate housings, and in electrical communication with each other.

The processor 202 may execute one or more operations for implementing various examples and embodiments described herein. The processor 202 can execute instructions stored in the memory 208 to perform the operations. The processor 202 can include one processing device or multiple processing devices. Non-limiting examples of the processor 202 include a Field-Programmable Gate Array (“FPGA”), an application-specific integrated circuit (“ASIC”), a microprocessor, etc.

The processor 202 may be communicatively coupled to the memory 208 via the bus 204. The non-volatile memory 208 may include any type of memory device that retains stored information when powered off. Non-limiting examples of the memory 208 include electrically erasable and programmable read-only memory (“EEPROM”), flash memory, or any other type of non-volatile memory. In some examples, at least some of the memory 208 may include a non-transitory computer-readable medium from which the processor 202 can read instructions. A computer-readable medium may include electronic, optical, magnetic, or other storage devices capable of providing the processor 202 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor may read instructions. The instructions may include processor-specific instructions generated by a compiler or an interpreter from code written in any suitable computer-programming language, including, for example, C, C++, C#, Perl, Java, Python, etc.

The communications interface 206 may interface other network devices or network-capable devices to analyze and receive information related to a performance indicator of the computer network 110. Information received from the communications interface 206 may be sent to the memory 208 via the bus 204. The memory 208 can store any information received from the communications interface 206.

The memory 208 may include program code for determining performance indicators for one or more computing devices 112 of the computer network 110. For example, the program code may cause the network performance engine 114, or any component within the network performance engine 114, to generate a health score 214, a heat map 215, a graphical user interface 216 that includes the health score 214 and the heat map 215, and the like in relation to the computer network 110. In some examples, the graphical user interface 216 may be presented to a user to allow the user to visualize the health score 214, the heat map 215, or both.

The health score 214 can be determined based on performance data relating to the respective computing device 112. For example, the network performance engine 114 can receive usage data and capacity data about the respective computing device 112. The usage data can include an amount of processing load or memory load on the respective computing device 112 over a period of time, and the capacity data can include an amount of processing and memory availability on the respective computing device 112 over the period of time. In some examples, the network performance engine 114 can determine the health score 214 by multiplying the usage data by the capacity data and normalizing the result to a fixed value. In other examples, the network performance engine 114 can separately integrate the usage data and the capacity data, and the network performance engine 114 can suitably combine (e.g., multiply, divide, etc.) the results to generate the health score 214. The network performance engine 114 can use other suitable techniques can be used to determine the health score 214.

The network performance engine 114 can additionally include an adjustment module 212. The adjustment module 212 may be configured to apply the health score 214, the heat map 215, and other suitable data to project or identify problems or potential problems in the computer network 110. For example, the adjustment module 212 can receive the health score 214, the heat map 215, or a combination thereof and can determine that a problem exists in the computer network 110 or predict that a problem may arise in the computer network 110. Accordingly, the adjustment module 212 can automatically perform one or more operations to prevent or mitigate the problems in the computer network 110. For example, the adjustment module 212 can determine that a particular computing device 112 is overutilized based on the health score 214 and the heat map 215, and the adjustment module 212 can automatically perform an operation to adjust the usage (e.g., by diverting processing tasks from or expanding capacity) with respect to the particular computing device 112 to reduce its utilization.

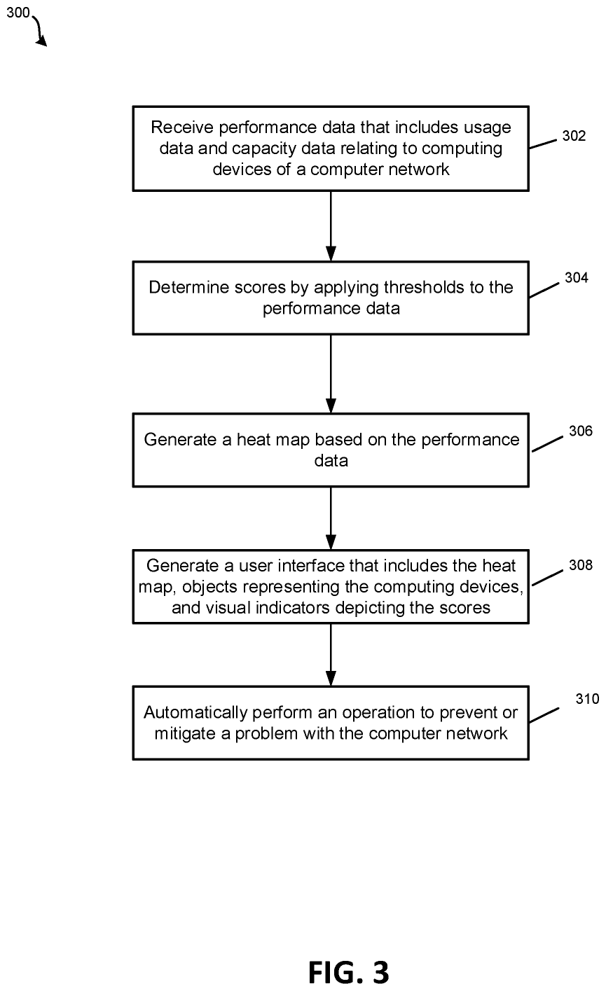

FIG. 3 is a flowchart of an example of a process for generating a graphical user interface that includes performance indicators according to one example of the present disclosure. Other examples may include more steps, fewer steps, different steps, or a different order of steps than is shown in FIG. 1. The process of FIG. 3 will now be described below with reference to the components of FIG. 1 describe above.

At block 302, the network performance engine 114 receives performance data corresponding to computing devices 112 of the computer network 110. The performance data can include usage data, capacity data, and other suitable performance data relating to the computing devices 112 of the computer network 110. The usage data can include an amount of processing load or memory load on the respective computing device 112 over a period of time. The usage data may also include other usage information, such as bandwidth usage and storage usage over a period of time. The capacity data can include an amount of processing and memory availability on the respective computing device 112 over the period of time. The capacity data may also include other capacity information, such as bandwidth capacity and storage capacity over the period of time. The network performance engine 114 can receive the performance data by communicating with the computing devices 112 in the computer network 110.

In some examples, the performance data can include memory values, processor values, and other suitable values indicating performance of the computing devices 112 of the computer network. The memory values and the processor values can correspond to the computing devices 112. For example, each memory value included in the memory values can indicate an amount of free memory space available on a respective computing device 112 of the computer network 110. Additionally, each processor value included in the processor values can indicate an amount of available processing capacity on the respective computing device 112 of the computer network 110.

At block 304, the network performance engine 114 determines scores 214 (e.g., health scores) by applying one or more thresholds and/or algorithms to the performance data. Each of the scores 214 can indicate the health of a respective computing device 112 of the computer network 110. In some examples, the health of a computing device can be an overall measure of the functional quality of a computing device. For example, the computing health scores 214 can be or otherwise include a holistic score for a computing device 112 such that the holistic score reflects the health of the computing device 112 based on usage and capacity of the computing device 112. The health scores 214 can include any other suitable indications with respect to the health of the respective computing device 112. In some examples, the health scores 214 can be aggregated or otherwise combined to produce a single collective health score, referred to herein as a network health score, representing the overall health of the computer network 110 as-a-whole. For example, the network health score may indicate the average overall health of the individual computing devices 112 included in the computer network 110.

In some examples, the one or more thresholds can include a first threshold range, a second threshold range, and any other suitable threshold ranges for determining the computing health scores 214 and other suitable information with respect to the respective computing device 112. The first threshold range can be associated with the memory values. For example, a particular memory value that is less than the first threshold range may indicate that computer memory of the respective computing device 112 is underutilized or otherwise not healthy. Additionally or alternatively, the particular memory value that is greater than the first threshold range may indicate that computer memory of the respective computing device 112 is overutilized or otherwise not healthy. In some examples, the particular memory value may be within the first threshold range, which may indicate a healthy or efficiently-used memory of the respective computing device 112.

The second threshold range can be associated with the processor values. For example, a particular processor value that is less than the second threshold range may indicate that computer processing of the respective computing device 112 is underutilized or otherwise not healthy. Additionally or alternatively, the particular processor value that is greater than the second threshold range may indicate that computer processing of the respective computing device 112 is overutilized or otherwise not healthy. In some examples, the particular processor value may be within the second threshold range, which may indicate healthy or efficiently-used computer processing of the respective computing device 112.

At block 306, a heat map 215 is generated based on the performance data. The heat map 215 may indicate overutilization, underutilization, or other suitable usage data with respect to one or more computing devices 112 of the computer network 110. For example, for each computing device 112 of the computer network 110, the network performance engine 114 may determine if the respective computing device 112 is overutilized, underutilized, efficiently utilized, or other suitable indications for computing device usage. The network performance engine 114 may assign a different visual indicator for each usage indicator determined by the network performance engine 114. For example, the network performance engine 114 may assign a first color (e.g., red) to an overutilized computing device, a second color (e.g., yellow) to an efficiently-used computing device, and a third color (e.g., green) to an underutilized computing device. Additionally or alternatively, the network performance engine 114 may assign a first pattern to an overutilized computing device, a second pattern to an efficiently-used computing device, and a third pattern to an underutilized computing device. The network performance engine 114 can generate and assign any other suitable visual indicators for visualizing usage of the computing devices 112 of the computer network 110.

In some examples, the heat map 215 can include a first color range, a second color range, and a third color range. The first color range may correspond to a first subset of the computing devices 112 of the computer network that include memory values or processor values that are less than the first threshold range or the second threshold range, respectively, indicating that the first subset of the computing devices 112 may be underutilized. The second color range may correspond to a second subset of the computing devices 112 of the computer network that include memory values or processor values that are greater than the first threshold range or the second threshold range, respectively, indicating that the second subset of the computing devices 112 may be overutilized. The third color range may correspond to a third subset of the computing devices 112 of the computer network that include memory values or processor values that are within the first threshold range and the second threshold range, respectively, indicating that the third subset of the computing devices 112 may be efficiently-utilized.

At block 308, the network performance engine 114 generates the graphical user interface 216 for visualizing the performance indicators of the computing devices 112 of the computer network 110. The graphical user interface 216 can include one or more interactive objects corresponding to the computing devices 112 of the computer network 110, visual indicators indicating the determined computing health scores 214, and the heat map 215. In some examples, the visual indicators can be included in the interactive objects, and the heat map 215 can include a different set of visual indictors applied to the interactive objects. For example, the health scores 214 can include one or more numerical scores indicating a health of the respective computing device 112. As another example, the visual indicator of the heat map 215 corresponding to the respective computing device 112 can include a particular color or pattern corresponding to usage data with respect to the respective computing device 112.

In some examples, the network performance engine 114 can generate the graphical user interface 216 that includes one or more interactive elements corresponding to one or more computing subnetworks of the computer network 110. The subnetworks of the computer network 110 may include a subset of the computing devices 112 of the computer network 110. The graphical user interface 216 may be configured to receive user input. For example, the network performance engine 114, via the graphical user interface 216, may receive user input indicating a user selection of a particular computing subnetwork of the computing subnetworks included on the graphical user interface 216. In some examples, the network performance engine 114 may receive the user input at a particular interactive element corresponding to the selected particular computing subnetwork. In response to receiving the user input, the network performance engine 114 may highlight a subpart of the heat map 215 corresponding to the particular computing subnetwork for visually indicating a health, a usage, or other information about the particular computing subnetwork. In some examples, highlighting the subpart of the heat map 215 may involve displaying the subpart of the heat map 215 by itself, focusing-in on the subpart of the heat map 215, visually enclosing (e.g., in a box) the subpart of the heat map 215, changing a color scheme or pattern of the subpart of the heat map 215, or other suitable techniques for highlighting the subpart of the heat map 215.

In some examples, the graphical user interface 216 can include graphical objects that correspond to the computing devices 112 that are included in the particular computing subnetwork of the computer network 110. The network performance engine 114 can, via the graphical user interface 216, receive the user selection, and the network performance engine 114 can highlight the graphical objects that correspond to the computing devices 112 included in the particular computing subnetwork. Highlighting the graphical objects can involve displaying the selected graphical objects by themselves, focusing-in on the selected graphical objects, visually enclosing (e.g., in a box) the selected graphical objects, changing a color scheme or pattern of the selected graphical objects, or other suitable techniques for highlighting the selected graphical objects.

Generating and providing the graphical user interface 216 with the performance indicators of the computer network 110 can facilitate real-world operations. For example, maintenance operations can be performed based on the scores 214, the heat map 215, or any other suitable data provided via the graphical user interface 216. Additionally or alternatively, computing operations can be optimized using the computing scores 214, the heat map 215, or any other suitable data provided via the graphical user interface 216 for reducing computing resources consumed by the computer network 110 to perform similar tasks.

At block 310, the network performance engine 114 performs an automated operation to mitigate or prevent health problems in the computer network 110. The network performance engine 114, or any component thereof such as the adjustment module 212, can predict or identify problems in the computer network 110. In some examples, the problem can include bottlenecked processing, unused or underused computing devices, or other similar problems. The network performance engine 114 can automatically perform an operation to mitigate or prevent the problem. For example, the network performance engine 114 can automatically divert or otherwise adjust processing tasks to prevent or mitigate the problem. Additionally or alternatively, the network performance engine 114 can automatically adjust (e.g., increase or decrease) the capacity of the respective computing device or computing devices. In some examples, the network performance engine 114 can implement these adjustments by communicating with one or more devices in the computer network and commanding them to modify their software or hardware settings.

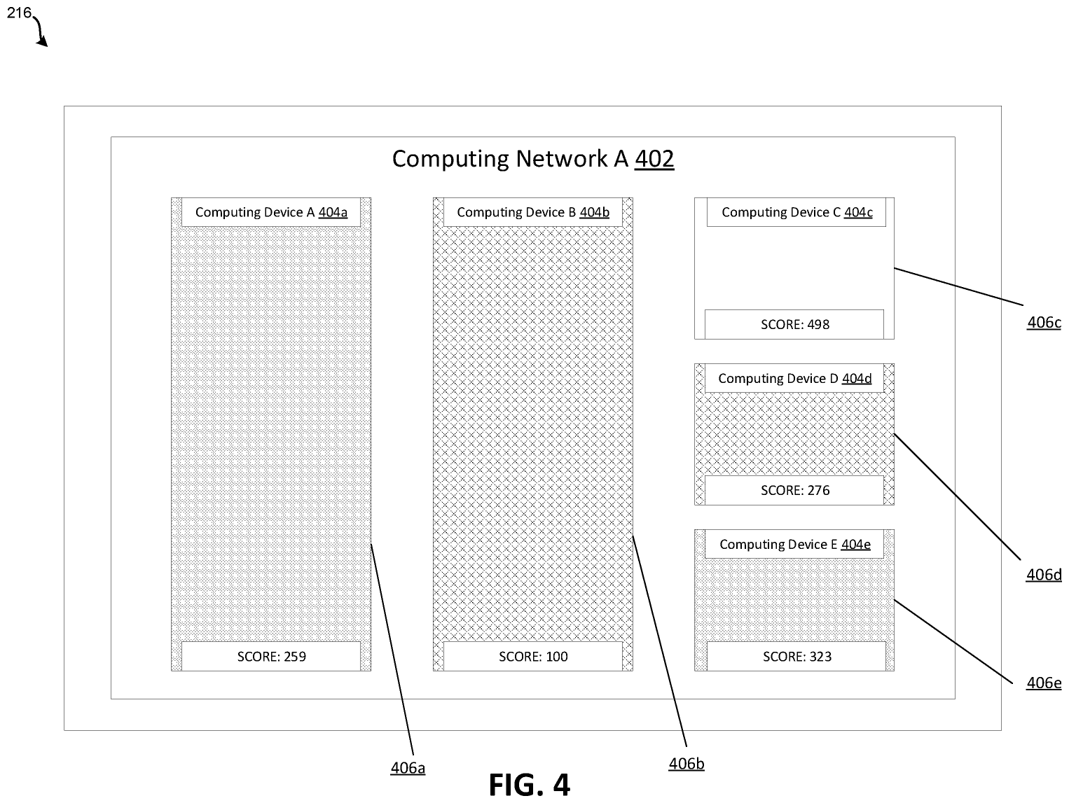

FIG. 4 is an example of a graphical user interface 216 according to one example of the present disclosure. As illustrated, the graphical user interface 216 includes an object 402 corresponding to the computer network 110 and objects 404a-e representing the computing devices 112 included in the computer network 110. Each object 404a-e can include a score and a visual indicator 406. For example, the object 404a includes a score of 259 and a visual indicator 406a, the object 404b includes a score of 100 and a visual indicator 406b, the object 404c includes a score of 498 and a visual indicator 406c, the object 404d includes a score of 276 and a visual indicator 406d, and the object 404e includes a score of 323 and a visual indicator 406e. The graphical user interface 216 can include any number of objects representing any number of computing devices in the computer network 110. And those objects can include any suitable information relating to usage, capacity, and health of the respective computing devices 112.

In some examples, the respective score included on an object 404 can indicate the health of the respective computing device 112. For example, the score of 100 corresponding to the object 404b may indicate that the health of the respective computing device 112 is low, whereas the score of 498 corresponding to the object 404c may indicate that the health of the respective computing device 112 is high.

In some examples, the graphical user interface 216 can include a heatmap. The heatmap may be formed from the graphical objects 404a-e or separate from the graphical objects 404a-e. In the example shown in FIG. 4, the heatmap is formed from the graphical objects 404a-e. In particular, the graphical objects 404a-e are color coded in accordance with the heatmap's color scheme to indicate the performance of the computing devices in the computer network. The graphical objects 404a-e can also be spatially arranged in the heatmap based on their performance values. In this way, each graphical object 404a-e can effectively serve as an individual visual element in the overall heatmap, which is constructed from the colors and arrangements of the graphical objects 404a-e. In other examples, the heatmap may be provided separately from the graphical elements and include an arrangement of colored boxes or other symbols, where each symbol represents one of the computing devices and is colored in accordance with the heatmap's color scheme to indicate the performance of that particular computing device. In some examples, the heath scores can be used to generate the heatmap. For example, the color coding for the individual elements in the heatmap can represent the health scores for the computing devices. Thus, the health of the computing devices may be represented in the graphical user interface 216 in two different ways concurrently—e.g., textually as numerical scores and graphically in a heatmap.

Although the subject matter has been described in language specific to structural features or methodological acts, it is to be understood that the subject matter defined in the appended claims is not necessarily limited to the specific features or acts described above. Rather, the specific features and acts described above are disclosed only for the purpose of illustration and description and they are not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A system comprising:
a processor device; and
a non-transitory computer-readable memory comprising instructions that are executable by the processor device to perform operations comprising:
receiving performance data relating to a plurality of computing devices in a computer network, the performance data comprising usage data and capacity data relating to each computing device of the plurality of computing devices;
determining a plurality of scores by applying a plurality of thresholds to the performance data, each score of the plurality of scores indicating a health of a corresponding computing device of the plurality of computing devices;
generating a heat map based on the performance data, the heat map visually indicating whether each computing device of the plurality of computing devices is experiencing overutilization or underutilization; and
generating a graphical user interface that includes:
the heat map;
a plurality of graphical objects representing the plurality of computing devices; and
a plurality of visual indicators and associated with the plurality of graphical objects, each visual indicator of the plurality of visual indicators corresponding to a respective graphical object of the plurality of graphical objects and depicting a respective score of the plurality of scores, the respective score indicating the health of the corresponding computing device represented by the respective graphical object.

2. The system of claim 1, wherein the performance data comprises:
a plurality of memory values, each memory value in the plurality of memory values corresponding to a respective computing device of the plurality of computing devices and indicating an amount of free memory space available on the respective computing device; and
a plurality of processor values, each processor value in the plurality of memory values corresponding to a respective computing device of the plurality of computing devices and indicating an amount of available processing capacity on the respective computing device.

3. The system of claim 2, wherein the plurality of thresholds comprises:
a first threshold range associated with the plurality of memory values, wherein:
a particular memory value of the plurality of memory values being less than the first threshold range indicates that computer memory of a corresponding computing device of the plurality of computing devices is underutilized; and
the particular memory value of the plurality of memory values being greater than the first threshold range indicates that computer memory of the corresponding computing device of the plurality of computing devices is overutilized; and
a second threshold range associated with the plurality of processor values, wherein:
a particular processor value of the plurality of processor values being less than the second threshold range indicates that computer processing of a corresponding computing device of the plurality of computing devices is underutilized; and
the particular processor value of the plurality of processor values being greater than the second threshold range indicates that computer processing of the corresponding computing device of the plurality of computing devices is overutilized.

4. The system of claim 3, wherein the heat map comprises a first color range, a second color range, and a third color range, and wherein:
the first color range corresponds to a first set of computing devices in the plurality of computing devices having corresponding memory values or corresponding processor values that are less than the first threshold range or the second threshold range, respectively;
the second color range corresponds to a second set of computing devices in the plurality of computing devices having corresponding memory values or corresponding processor values greater than the first threshold range or the second threshold range, respectively; and
the third color range corresponds to a third set of computing devices in the plurality of computing devices having corresponding memory values or corresponding processor values within the first threshold range and the second threshold range.

5. The system of claim 1, wherein the plurality of scores further comprises a network health score that indicates a collective health of the plurality of computing devices in the computer network as a whole.

6. The system of claim 5, wherein the operations further comprise:
including, in the graphical user interface, one or more interactive elements corresponding to a plurality of computing subnetworks that are subparts of the computer network, wherein each interactive element of the one or more interactive elements corresponds to a respective computing subnetwork of the plurality of computing subnetworks;
receiving, at a particular interactive element of the one or more interactive elements, a user selection for a particular computing subnetwork of the plurality of computing subnetworks; and
in response to receiving the user selection at the particular interactive element, highlighting a subpart of the heat map that corresponds to the particular computing subnetwork for visually indicating a health of the particular computing subnetwork.

7. The system of claim 6, wherein the plurality of computing devices are included in the particular computing subnetwork, wherein the plurality of graphical objects corresponds to the plurality of computing devices included in the particular computing subnetwork, and wherein the operations further comprise:
in response to receiving the user selection, highlighting the plurality of graphical objects and the plurality of visual indicators that correspond to the particular computing subnetwork.

8. A method comprising:
receiving, by a computing device, performance data relating to a plurality of computing devices in a computer network, the performance data comprising usage data and capacity data relating to each computing device of the plurality of computing devices;
determining, by the computing device, a plurality of scores by applying a plurality of thresholds to the performance data, each score of the plurality of scores indicating a health of a corresponding computing device of the plurality of computing devices;
generating, by the computing device, a heat map based on the performance data, the heat map visually indicating whether each computing device of the plurality of computing devices is experiencing overutilization or underutilization; and
generating, by the computing device, a graphical user interface that includes:
the heat map;
a plurality of graphical objects representing the plurality of computing devices; and
a plurality of visual indicators and associated with the plurality of graphical objects, each visual indicator of the plurality of visual indicators corresponding to a respective graphical object of the plurality of graphical objects and depicting a respective score of the plurality of scores, the respective score indicating the health of the corresponding computing device represented by the respective graphical object.

9. The method of claim 8, wherein the performance data comprises:
a plurality of memory values, each memory value in the plurality of memory values corresponding to a respective computing device of the plurality of computing devices and indicating an amount of free memory space available on the respective computing device; and
a plurality of processor values, each processor value in the plurality of memory values corresponding to a respective computing device of the plurality of computing devices and indicating an amount of available processing capacity on the respective computing device.

10. The method of claim 9, wherein the plurality of thresholds comprises:
a first threshold range associated with the plurality of memory values, wherein:
a particular memory value of the plurality of memory values being less than the first threshold range indicates that computer memory of a corresponding computing device of the plurality of computing devices is underutilized; and
the particular memory value of the plurality of memory values being greater than the first threshold range indicates that computer memory of the corresponding computing device of the plurality of computing devices is overutilized; and
a second threshold range associated with the plurality of processor values, wherein:
a particular processor value of the plurality of processor values being less than the second threshold range indicates that computer processing of a corresponding computing device of the plurality of computing devices is underutilized; and
the particular processor value of the plurality of processor values being greater than the second threshold range indicates that computer processing of the corresponding computing device of the plurality of computing devices is overutilized.

11. The method of claim 10, wherein the heat map comprises a first color range, a second color range, and a third color range, and wherein:
the first color range corresponds to a first set of computing devices in the plurality of computing devices having corresponding memory values or corresponding processor values that are less than the first threshold range or the second threshold range, respectively;
the second color range corresponds to a second set of computing devices in the plurality of computing devices having corresponding memory values or corresponding processor values greater than the first threshold range or the second threshold range, respectively; and
the third color range corresponds to a third set of computing devices in the plurality of computing devices having corresponding memory values or corresponding processor values within the first threshold range and the second threshold range.

12. The method of claim 8, wherein the plurality of scores further comprises a network health score that indicates a collective health of the plurality of computing devices in the computer network as a whole.

13. The method of claim 12, further comprising:
including, by the computing device and in the graphical user interface, one or more interactive elements corresponding to a plurality of computing subnetworks that are subparts of the computer network, wherein each interactive element of the one or more interactive elements corresponds to a respective computing subnetwork of the plurality of computing subnetworks;
receiving, by the computing device and at a particular interactive element of the one or more interactive elements, a user selection for a particular computing subnetwork of the plurality of computing subnetworks; and
in response to receiving the user selection at the particular interactive element, highlighting, by the computing device, a subpart of the heat map that corresponds to the particular computing subnetwork for visually indicating a health of the particular computing subnetwork.

14. The method of claim 13, wherein the plurality of computing devices are included in the particular computing subnetwork, wherein the plurality of graphical objects corresponds to the plurality of computing devices included in the particular computing subnetwork, and wherein the method further comprises:
in response to receiving the user selection, highlighting, by the computing device, the plurality of graphical objects and the plurality of visual indicators that correspond to the particular computing subnetwork.

15. A non-transitory computer-readable medium comprising instructions that are executable by a processor for causing the processor to perform operations comprising:
receiving performance data relating to a plurality of computing devices in a computer network, the performance data comprising usage data and capacity data relating to each computing device of the plurality of computing devices;
determining a plurality of scores by applying a plurality of thresholds to the performance data, each score of the plurality of scores indicating a health of a corresponding computing device of the plurality of computing devices;
generating a heat map based on the performance data, the heat map visually indicating whether each computing device of the plurality of computing devices is experiencing overutilization or underutilization; and
generating a graphical user interface that includes:
the heat map;
a plurality of graphical objects representing the plurality of computing devices; and
a plurality of visual indicators and associated with the plurality of graphical objects, each visual indicator of the plurality of visual indicators corresponding to a respective graphical object of the plurality of graphical objects and depicting a respective score of the plurality of scores, the respective score indicating the health of the corresponding computing device represented by the respective graphical object.

16. The non-transitory computer-readable medium of claim 15, wherein:
the performance data comprises:
a plurality of memory values, each memory value in the plurality of memory values corresponding to a respective computing device of the plurality of computing devices and indicating an amount of free memory space available on the respective computing device; and
a plurality of processor values, each processor value in the plurality of memory values corresponding to a respective computing device of the plurality of computing devices and indicating an amount of available processing capacity on the respective computing device; and
the plurality of thresholds comprises:
a first threshold range associated with the plurality of memory values, wherein:
a particular memory value of the plurality of memory values being less than the first threshold range indicates that computer memory of a corresponding computing device of the plurality of computing devices is underutilized; and
the particular memory value of the plurality of memory values being greater than the first threshold range indicates that computer memory of the corresponding computing device of the plurality of computing devices is overutilized; and
a second threshold range associated with the plurality of processor values, wherein:
a particular processor value of the plurality of processor values being less than the second threshold range indicates that computer processing of a corresponding computing device of the plurality of computing devices is underutilized; and
the particular processor value of the plurality of processor values being greater than the second threshold range indicates that computer processing of the corresponding computing device of the plurality of computing devices is overutilized.

17. The non-transitory computer-readable medium of claim 16, wherein the heat map comprises a first color range, a second color range, and a third color range, and wherein:
the first color range corresponds to a first set of computing devices in the plurality of computing devices having corresponding memory values or corresponding processor values that are less than the first threshold range or the second threshold range, respectively;
the second color range corresponds to a second set of computing devices in the plurality of computing devices having corresponding memory values or corresponding processor values greater than the first threshold range or the second threshold range, respectively; and
the third color range corresponds to a third set of computing devices in the plurality of computing devices having corresponding memory values or corresponding processor values within the first threshold range and the second threshold range.

18. The non-transitory computer-readable medium of claim 15, wherein the plurality of scores further comprises a network health score that indicates a collective health of the plurality of computing devices in the computer network as a whole.

19. The non-transitory computer-readable medium of claim 18, wherein the operations further comprise:
including, in the graphical user interface, one or more interactive elements corresponding to a plurality of computing subnetworks that are subparts of the computer network, wherein each interactive element of the one or more interactive elements corresponds to a respective computing subnetwork of the plurality of computing subnetworks;
receiving, at a particular interactive element of the one or more interactive elements, a user selection for a particular computing subnetwork of the plurality of computing subnetworks; and
in response to receiving the user selection at the particular interactive element, highlighting a subpart of the heat map that corresponds to the particular computing subnetwork for visually indicating a health of the particular computing subnetwork.

20. The non-transitory computer-readable medium of claim 19, wherein the plurality of computing devices are included in the particular computing subnetwork, wherein the plurality of graphical objects corresponds to the plurality of computing devices included in the particular computing subnetwork, and wherein the operations further comprise:
in response to receiving the user selection, highlighting the plurality of graphical objects and the plurality of visual indicators that correspond to the particular computing subnetwork.
